(19) United States
(12) Patent Application Publication
(10) Pub. No.: US 2012/0320397 A1
(43) Pub. Date: Dec. 20, 2012

(54) DISPLAY DEVICE AND IMAGE FORMING APPARATUS

(75) Inventor: Ken Kishimoto, Osaka (JP)

(73) Assignee: Sharp Kabushiki Kaisha, Osaka (JP)

(21) Appl. No.: 13/495,321

(22) Filed: Jun. 13, 2012

(30) Foreign Application Priority Data
Jun. 15, 2011 (JP) 2011-132919

(51) Int. Cl. G06K 15/02

(52) U.S. Cl. 358/1.13

(57) ABSTRACT

A display device of an image forming apparatus is provided with a display panel, a backlight unit, a storage portion, and a control portion. The display panel is a transmission type display panel and displays display data. The backlight unit emits light to the back side of the display panel. The storage portion stores a plurality of kinds of display data displayed on the display panel and a plurality of kinds of luminance data set up corresponding to each of the plurality of kinds of display data. The control portion reads out from the storage portion the display data to be displayed on the display panel and the luminance data corresponding to the display data, displays the read display data on the display panel, and performs display control for controlling the luminance of the backlight unit based on the read luminance data.

### CROSS REFERENCE

This Nonprovisional application claims priority under 35 U.S.C. §119(a) on Patent Application No. 2011-132919 filed in Japan on Jun. 15, 2011, the entire contents of which are hereby incorporated by reference.

### BACKGROUND OF THE INVENTION

The present invention relates to a display device provided with a back light unit, and an image forming apparatus provided with such a display device.

Display devices provided with a non-light-emitting and transmission type display panel such as a liquid crystal panel include a backlight on a back side of the display panel in order to make display data displayed on the display panel easy to view.

Some conventional display devices are made to shift from a normal mode to a standby mode when a state in which no operation is performed lasts for a fixed time in order to reduce power consumption. A display device disclosed in Japanese Patent Laid-Open Publication No. JP 2003-162261, for example, lowers the luminance of a backlight when the display device shifts to the standby mode, and reduces the frequency of rewriting display data and thereby reduces electric power consumption by converting color display data displayed on the display panel to monochrome display data.

The life of the backlight of display devices will become longer when the display devices are used to lower luminance. However, in the conventional display devices, when the standby mode is shifted to the normal mode, regardless of the display data displayed on the display panel, the monochrome display data is uniformly converted to the color display data, and the luminance of the backlight is uniformly changed from low luminance into normal luminance (high luminance). For this reason, a period of time to turn on the backlight with a high luminance becomes long and the life of the backlight becomes short as time when the display device is used in the normal mode becomes longer. Additionally, when the display devices are shifted from the standby mode to the normal mode, the power consumption of the device will increase.

In view of the foregoing problems, it is an object of the present invention to provide a display device capable of extending the life of a backlight unit and reducing power consumption, and to provide an image forming apparatus provided with such a display device.

### SUMMARY OF THE INVENTION

A display device of the present invention is provided with a display panel, a backlight unit, a storage portion, and a control portion. The display panel is transmissive and displays display data. The backlight unit emits light to the back side of the display panel. The storage portion stores a plurality of kinds of display data displayed on the display panel and a plurality of kinds of luminance data set up corresponding to each of the plurality of kinds of display data. The control portion reads out from the storage portion the display data to be displayed on the display panel and the luminance data corresponding to the display data, displays the read display data on the display panel, and performs display control for controlling the luminance of the backlight unit based on the read luminance data.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a perspective external view of an image forming apparatus provided with a display device according to an embodiment of the present invention;

FIG. 2A is an external view of a display panel as an exemplary display device, FIG. 2B is a sectional view of the display panel, and FIG. 2C is a front view showing a part of a backlight unit;

FIG. 3 is a front perspective view showing an internal configuration of the image forming apparatus;

FIG. 4 is a block diagram showing a control system of the image forming apparatus provided with the display device;

FIG. 5 is a view showing a correlation relationship between display data and luminance data which are stored by a storage portion;

FIG. 6 is a flow chart explaining an operation of the image forming apparatus;

FIG. 7A shows a standby screen, FIG. 7B shows a print job history screen, FIG. 7C shows a copy ratio screen, and FIG. 7D shows a special feature screen; and

FIG. 8A shows an allocation printing screen, FIG. 8B shows a color adjustment screen, FIG. 8C shows an RGB adjustment screen, and FIG. 8D shows a print job screen.

### DETAILED DESCRIPTION OF THE INVENTION

Hereinafter, an image forming apparatus provided with a panel unit as an exemplary display device according to an embodiment of the present invention is exemplified and described.

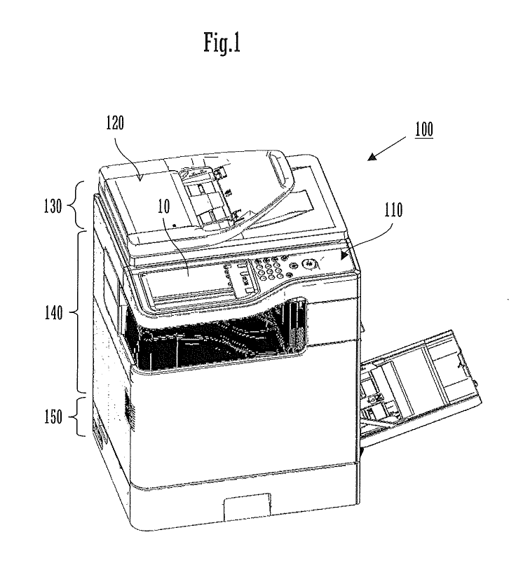

As shown in FIG. 1, the image forming apparatus 100 is provided with a panel unit 110, an automatic document feeding portion 120, an image reading portion 130, an image forming portion 140, and a paper feeding portion 150. The panel unit 110 is provided with a display operating section 10.

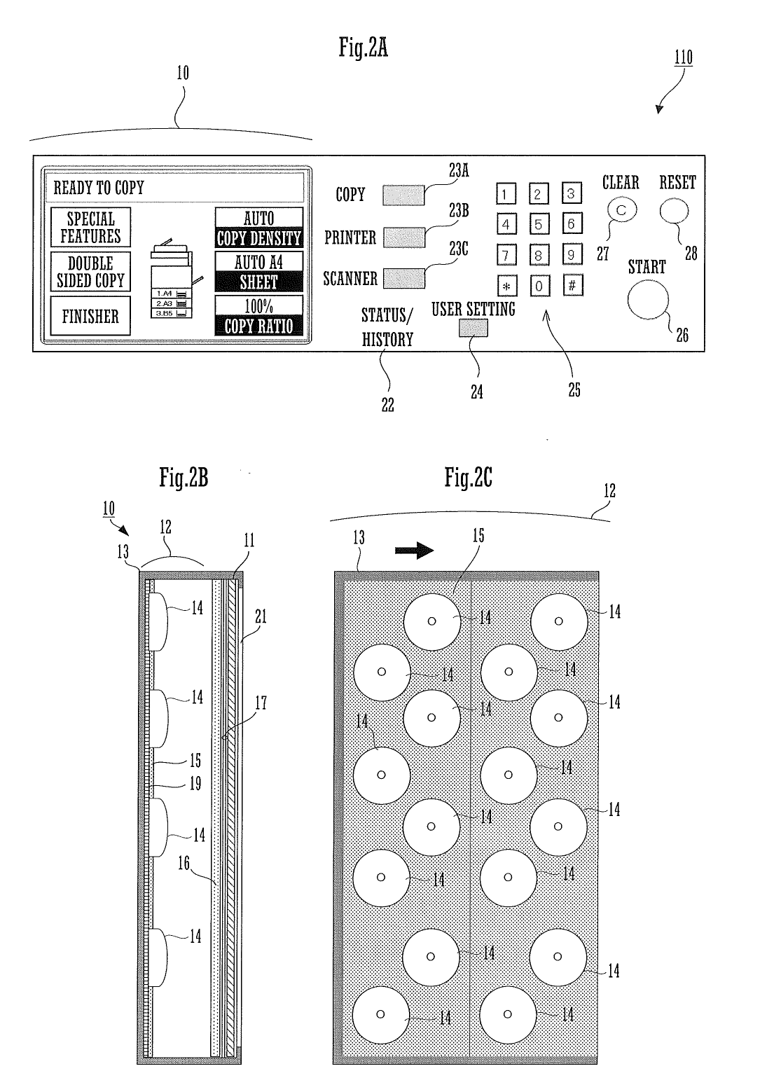

The panel unit 110 is installed at a front side of the upper part of the apparatus main body of the image forming apparatus 100. As shown in FIG. 2A, the panel unit 110 includes a display operating portion 10, a job status/history button 22, a copy selection button 23A, a printer selection button 23B, a scanner selection button 23C, a user setting button 24, numeric keys 25, a start button 26, a clear button 27, and a reset button 28.

As shown in FIGS. 2B and 2C, the display operating section 10 is provided with a display panel 11, a backlight unit 12, a housing 13, and a touch panel 21. The display panel 11 is a transmission type display panel and is held by the housing 13. The display panel 11 displays color display data and monochrome display data. The backlight unit 12 is arranged at an inner side of the housing 13 and at the back side of the display panel 11, and emits light to the back side of the display panel 11.

The backlight unit 12 is provided with a plurality of LEDs 14, a reflective sheet 15, a diffuser plate 16, a diffuser sheet 17, and a backlight substrate 19. The backlight unit 12 may be provided with a fluorescence tube (a CCFT pipe) in place of the LEDs 14.

The plurality of LEDs 14 are mounted on the backlight substrate 19 at a predetermined interval. The reflective sheet 15 is installed on a surface opposed to the diffuser plate 16 of the backlight substrate 19. The reflective sheet 15 reflects light which the LEDs 14 emit in a direction of the display panel 11.

The touch panel 21 is installed on a surface side of the display panel 11. The touch panel 21 outputs a detection signal which specifies a position pressed by a user with a finger.

The image forming apparatus 100 displays display data of various kinds of selection buttons, display data showing a current operating state, etc. on the display panel 11. In addition, the image forming apparatus 100 accepts an operation by a user from the panel unit 110. The user can use the image forming apparatus 100 to perform print jobs such as copy, print, and scan and reading jobs by operating the touch panel 21 and each of the various operation buttons 22 to 28.

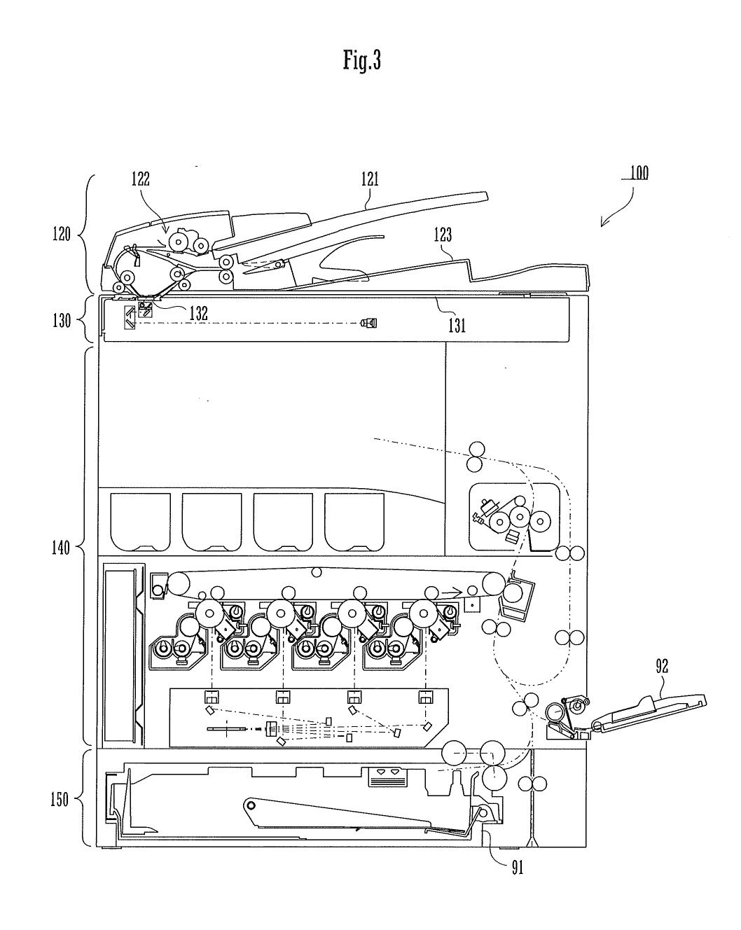

As shown in FIG. 3, the image reading portion 130 is provided on the upper surface thereof a first document platen 131 and a second document platen 132 on the upper surface. The automatic document feeding portion 120 supports the upper surface of the first document platen 131 and the second document platen 132 in a freely openable and closable manner, and feeds documents one by one from a document load tray 121 to a document output tray 123 through the second document platen 132 by a feeding unit 122 in a fed document reading mode.

The image reading portion 130 reads a document passing on the second document platen 132 in the fed document reading mode to generate print image data and reads a document placed on the first document platen 131 to generate print image data in a fixed document reading mode.

The image forming portion 140 forms a monochrome or color image on a sheet which is fed from a paper feed tray 91 or 92 of the paper feeding portion 150 by an electrophotographic image forming process as an example. The sheet includes recording media such as a plain paper sheet, a thick paper sheet, and an OHP film.

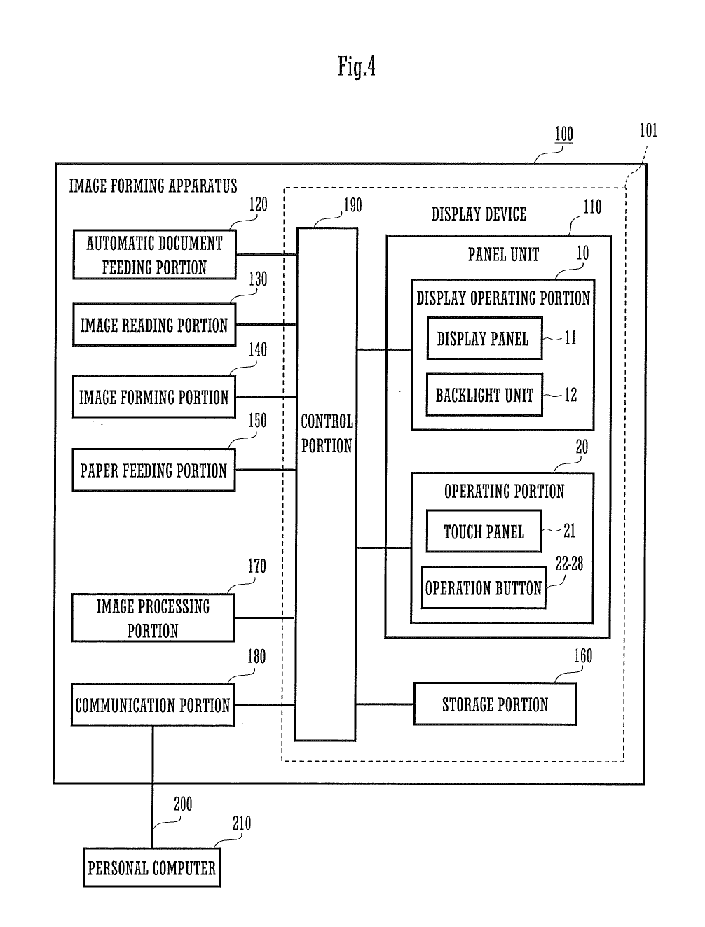

As shown in FIG. 4, in the image forming apparatus 100, the display operating section 10, the automatic document feeding portion 120, the image reading portion 130, the image forming portion 140, the paper feeding portion 150, the storage portion 160, an image processing portion 170, and a communication portion 180 are connected to the control portion 190.

In the image forming apparatus 100, the display operating section 10, the storage portion 160, and the control portion 190 constitute the display device 101 of the present invention.

The control portion 190 performs control of the display operating section 10, the automatic document feeding portion 120, the image reading portion 130, the image forming portion 140, and the paper feeding portion 150 when the operation by a user is accepted by the panel unit 110. Moreover, the control portion 190 performs image formation by the image forming portion 140 when a print job is received from a personal computer 210 through a communication line 200 in the communication portion 180. Further, the control portion 190 performs image processing by the image processing portion 170 when the image processing to the print image data read by the image reading portion 130 and the print image data included in the print job received in the communication portion 180 is necessary. The image reading portion 130 and the communication portion 180 are equivalent to a receiving portion of the present invention.

The storage portion 160 stores a processing program which the control portion 190 executes, a plurality of kinds of display data displayed on the display panel 11 of the display operating portion 10, a plurality of kinds of luminance data for controlling the luminance of the backlight unit 12, and so on. The plurality of kinds of luminance data is set to the luminance corresponding to each of the plurality of kinds of display data.

In the image forming apparatus 100, when the backlight unit 12 of the display operating portion 10 is statically lit, the luminance of the backlight unit 12 is lowered by lowering the voltage applied to the backlight unit 12. Alternatively, when the backlight unit 12 of the display operating portion 10 is dynamically lit (pulse lit), the luminance of the backlight unit 12 is lowered by changing an ON/OFF duty ratio.

The control portion 190 of the image forming apparatus 100 controls the luminance of the backlight unit 12 to three levels of luminance: normal luminance (high luminance), medium luminance, and low luminance, for an example, in a case where display data is displayed on the display panel 11 of the display operating section 10.

In the static lighting system, the rated voltage is applied in a case where the backlight unit 12 is lit with normal luminance. In the dynamic lighting system, the ON/OFF duty ratio is set up to 100%, 50%, and 20% corresponding to normal luminance, medium luminance, and low luminance of the backlight unit 12, respectively.

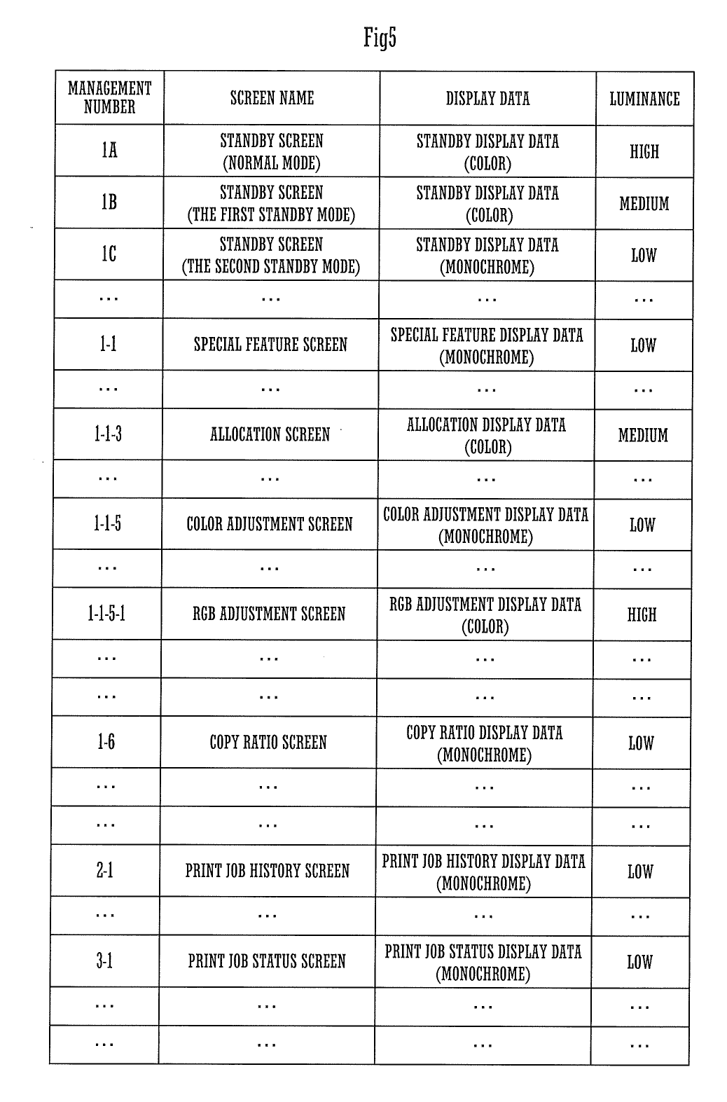

The storage portion 160 associates and stores a plurality of kinds of display data and a plurality of kinds of luminance data of the backlight unit 12, the display data being displayed on the display panel 11 of the display operating portion 10 and the luminance data being set corresponding to each of the plurality of kinds of display data. For example, the storage portion 160, as shown in FIG. 5, associates and stores a management number, a screen name, display data displayed on the display panel 11, and luminance data of the backlight unit 12.

In this way, when the image forming apparatus 100 shifts from the standby mode to the normal mode, the backlight unit 12 is lit with the luminance according to the display data displayed on the display panel 11.

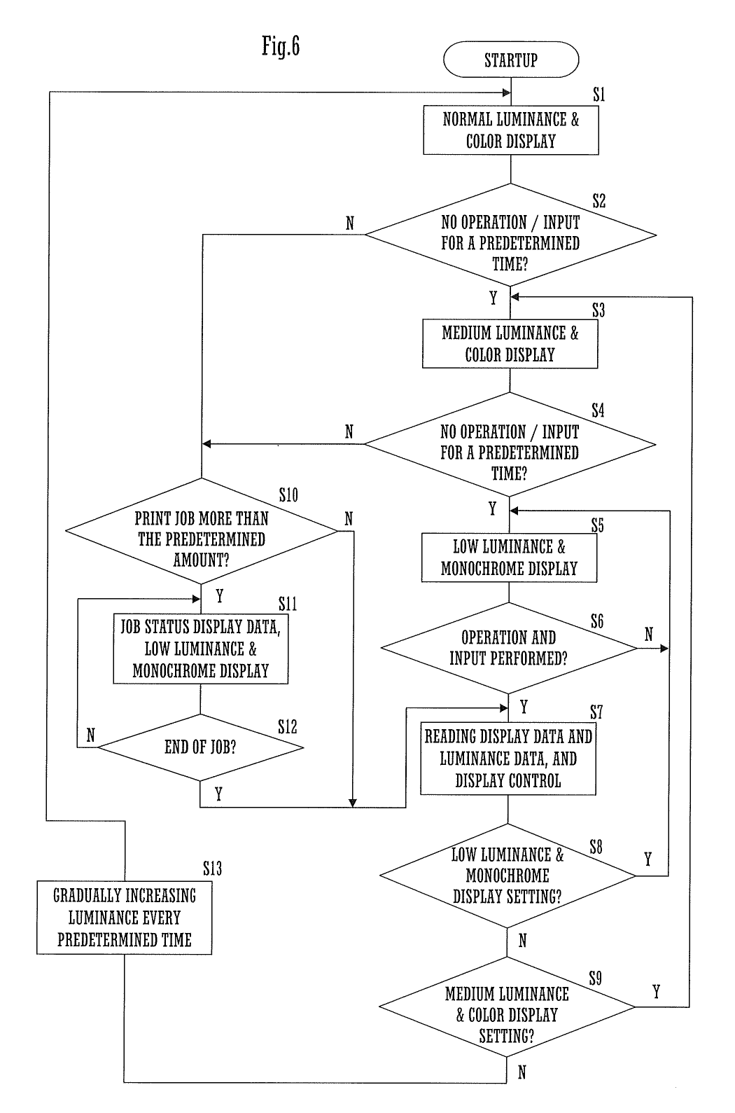

Subsequently, operation of the image forming apparatus 100 is described based on the flow chart shown in FIG. 6.

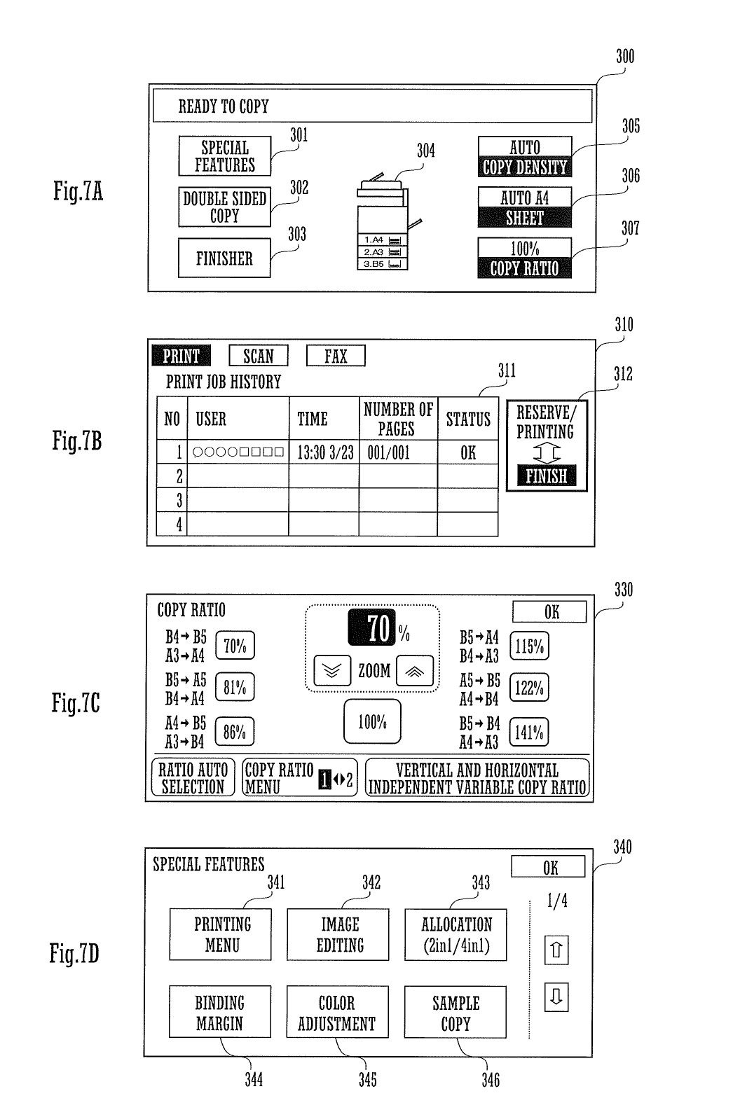

The control portion 190 of the image forming apparatus 100 reads and executes a control program from the storage portion 160 when being switched on. The control portion 190 reads color standby display data of as the display data of the management number 1A displayed at a time of startup and the corresponding luminance data from the storage portion 160. Then, the control portion 190 displays display data as shown in FIG. 7A on the display panel 11 of the display operating portion 10 and controls the luminance of the backlight unit 12 to normal luminance (S1). The control portion 190 starts measuring time when being brought into a state where the control portion can execute a print job, and awaits reception of an operation from to the display operating portion 10 and a print job from the personal computer 210 in the communication portion 180 (S2). This state is called a normal mode.

The control portion 190 shifts from the normal mode to a first standby mode if no reception of an operation from the display operating portion 10 or a print job from the personal computer 210 in the communication portion 180 (Y in S2) even when a predetermined time (5 minutes, for example) passes after starting measuring time. At this time, the control portion 190 aims at reduction of power consumption by lowering a temperature of a part necessary to be heated in the image forming portion 140.

In addition, in the first standby mode, the storage portion 160 reads the display data and the luminance data of the management number 1B and the control portion 190 changes the luminance of the backlight unit 12 of the display operating section 10 from normal luminance (high luminance) to medium luminance and newly starts measuring time (S3). It should be noted that the standby display data in the normal mode (color) and the standby display data in the first standby mode (color) are the same data.

The control portion 190 shifts from the first standby mode to the second standby mode if no reception of an operation by a user or a print job from the personal computer 210 is detected (Y in S4) even when a predetermined time (5 minutes, for example) passes after changing the luminance of the backlight unit 12 to the medium luminance. At this time, the control portion 190 reads the display data and the luminance data of the management number 1C from the storage portion 160. Then, the control portion 190 changes the color standby display data being displayed on the display panel 11 to monochrome standby display data. Additionally, the control portion 190 changes the luminance of the backlight unit 12 to low luminance (S5). It should be understood that the color standby display data in the first standby mode and the monochrome standby display data in the second standby mode have the same content, but different colors.

Thus, since the luminance of the backlight unit is not changed rapidly by changing the luminance of the backlight unit 12 every predetermined time, the power consumption of the display device can be reduced without giving discomfort to the user who is looking at the display of the display device. The life of the backlight unit 12 can also be extended.

It is to be noted that a user can change the predetermined time in Step S2 and Step S4.

The control portion 190 continues displaying the monochrome standby display data on the display panel 11 and controlling the luminance of the backlight unit 12 to the low luminance (S5) when detecting no reception of an operation by a user, or a print job from the personal computer 210 (N in S6).

On the other hand, the control portion 190 shifts from the second standby mode to the normal mode when detecting reception of an operation by a user, or a print job from the personal computer 210 (Y in S6). The control portion 190 reads the display data and the luminance data according to the accepted operation or the detected job from the storage portion 160. Then, the control portion 190 displays the read display data on the display panel 11 and performs the display control for controlling the luminance of the backlight unit to the luminance corresponding to the display data (S7).

In the case where the read display data is monochrome display data, and the luminance data is set to low luminance data (Y in S8), the control portion 190 displays the monochrome display data on the display panel 11 and controls the luminance of the backlight unit 12 to low luminance (S5).

For example, the control portion 190, when detecting operations of the job status/history button 22 and the copy selection button 23A of the panel unit 110, reads the display data and the luminance data of the management number 2-1 from the storage portion 160. Then, the control portion 190 displays the monochrome print job history display data as shown in FIG. 7B on the display panel 11, and sets the luminance of the backlight unit 12 to low luminance.

The control portion 190, when detecting by the touch panel 21 an operation of the copy ratio button 305 on the standby screen 300 shown in FIG. 7A, reads the display data and the luminance data of the management number 1-6 from the storage portion 160. Then, the control portion 190 displays the monochrome copy ratio display data as shown in FIG. 7C on the display panel 11, and sets the luminance of the backlight unit 12 to low luminance.

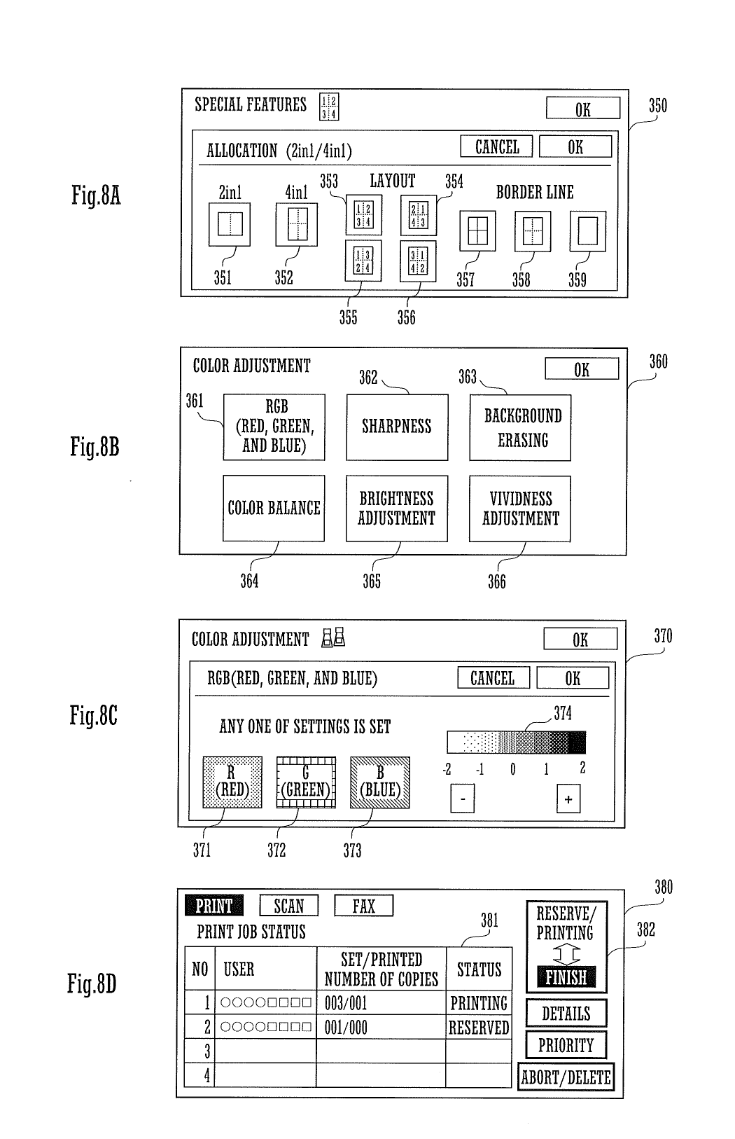

Like the print job history display data shown in FIG. 7B and the copy ratio display data shown in FIG. 7C, if the display data displayed on the display panel 11 is display data that contains a character and a table, and display data that contains only characters, a user can sufficiently identify the content of the display data by the display data displayed in monochrome on the display panel 11 even when the luminance of the backlight unit 12 is set to low luminance. Accordingly, in the image forming apparatus 100 (the display device 101), when the normal mode is shifted to the second standby mode, the display data having the above features is displayed in monochrome on the display panel 11, and the luminance of the backlight unit 12 is set to low luminance. It is also to be noted that the data described later such as the special feature display data shown in FIG. 7D, the color adjustment display data shown in FIG. 8B, and the print job situation display data shown in FIG. 8D is displayed in monochrome on the display panel 11 for the same reason, and the luminance of the backlight unit 12 is set to low luminance.

The control portion 190 displays color display data on the display panel 11 and controls the luminance of the backlight unit 12 to medium luminance in a case where the read display data is color display data and the luminance data is set to medium luminance (N in S8, Y in S9).

For example, the control portion 190, when detecting by the touch panel 21 an operation of the special feature button 301 of the standby screen 300 shown in FIG. 7A, reads the display data and the luminance data of the management number 1-1 from the storage portion 160. Then, the monochrome special feature display data shown in FIG. 7D is displayed on the display panel 11, and the luminance of the backlight unit 12 is set to low luminance. Subsequently, the control portion 190, when detecting by the touch panel 21 an operation of the allocation (2 in 1, 4 in 1) button 343 of the special feature screen 340 shown in FIG. 7D, reads the display data and the luminance data of the management number 1-1-3 from the storage portion 160. Then, the color allocation display data shown in FIG. 8A is displayed on the display panel 11, and the luminance of the backlight unit 12 is set to medium luminance.

Like the allocation display data shown in FIG. 8A, if the display data displayed on the display panel 11 is display data necessary to be classified by color, such as display data that contains a character and a figure, the display data becomes difficult to see when the luminance of the backlight unit is controlled to low luminance. In attempt to overcome such a problem, in the image forming apparatus 100 (the display device 101), when the normal mode is shifted to the second standby mode, the display data having the above features is displayed in color on the display panel 11, and the luminance of the backlight unit 12 is set to medium luminance.

In a case where the read display data is color display data and the luminance data is set to normal luminance (N in S8, N in S9), the control portion 190 displays color display data on the display panel 11 and controls the luminance of the backlight unit 12 to normal luminance (S1).

For example, the control portion 190, when detecting by the touch panel 21 an operation of the color adjustment button 345 of the special feature screen 340 shown in FIG. 7D, reads the display data and the luminance data of the management number 1-1-5 from the storage portion 160. Then, the monochrome color adjustment display data shown in FIG. 8B is displayed on the display panel 11, and the luminance of the backlight unit 12 is set to low luminance. Subsequently, the control portion 190, when detecting by the touch panel 21 an operation of an RGB (red, green, and blue) adjustment button 361 of the color adjustment screen 360 shown in FIG. 8B, reads the display data and the luminance data of the management number 1-1-5-1 from the storage portion 160. Finally, the color RGB adjustment display data shown in FIG. 8C is displayed on the display panel 11, and the luminance of the backlight unit 12 is set to normal luminance.

Like the RGB adjustment display data shown in FIG. 8C, if the display data displayed on the display panel 11 is display data to be displayed in color or display data that contains a very fine character and a figure, the display data becomes difficult to see if the luminance of the backlight unit is made lower than normal luminance (high luminance). Thus, in the image forming apparatus 100 (the display device 101), when the normal mode is shifted to the second standby mode, the display data having the above features is displayed in color on the display panel 11, and the luminance of the backlight unit 12 is set to normal luminance (high luminance).

The control portion 190 may be set to change luminance gradually in a case where the luminance of the backlight unit is changed from low luminance to high luminance. The image forming apparatus makes the image forming portion in the standby state as mentioned above in the second standby mode, and needs about 60 seconds, for example, to return to a state where printing is possible. In this case, in Step S6, when detecting an operation by a user, the control portion 190 reads from the storage portion 160 display data indicating that the mode is being shifted to normal mode, displays the display data on the display panel 11, and controls the luminance of the backlight unit 12 to low luminance. The control portion 190 changes the luminance of the backlight unit 12 to medium luminance after the lapse of 30 seconds (S12). Then, after the lapse of another 30 seconds, that is, 60 seconds after detecting the operation by a user in Step S6, the control portion 190 changes the luminance of the backlight unit 12 to high luminance (S1). Alternatively, the luminance of the backlight unit 12 may be made to gradually change from low luminance to high luminance (S13). In this way, since the luminance of the backlight unit 12 changes gradually, luminance can be changed without giving discomfort to a user.

In Step S2 or Step S4, in a case where the control portion 190 accepts an operation by a user or a print job from the personal computer 210 (N in S2 or N in S4) by a time when a predetermined time (for 5 minutes, for example) passes, the control portion 190 confirms whether a job to be performed is a print job in which the printing number of sheets is not less than a predetermined quantity, more than 10 sheets, for example (S10). The control portion 190 reads the display data and the luminance data of the management number 3-1 from the storage portion 160 in a case where the job to be performed is a print job in which the printing number of sheets is not less than 10 sheets (Y in S10). Then, the monochrome print job status display data shown in FIG. 8D is displayed on the display panel 11 and the luminance of the backlight unit 12 is set to low luminance (S11).

The control portion 190 displays confirmation display data of the progress status of the print job on the display operating portion 10 without changing a display state until the print job is completed (N in S12, S11). The control portion 190 performs the processing in Step S7 when the print job is completed (Y in S12).

The control portion 190 also performs the processing in Step S7 in a case where the processing accepted in Step S2 or Step S4 differs from a print job in which the printing number of sheets is not less than 10 sheets (N in S10).

In these cases, the control portion 190 reads the display data corresponding to the job to be performed and the luminance data corresponding to the display data from the storage portion 160. Then, the control portion 190 displays the read display data on the display panel 11 and controls the luminance of the backlight unit 12 based on the read luminance data.

In this way, in the image forming apparatus 100, not only when time when a job is not performed has elapsed for a predetermined time but also when an operation by a user is performed and a job is inputted, the luminance is lowered according to the content of the display data displayed when the accepted job is performed and the color of the display data is changed to improve visibility.

Although the illustrative embodiment described above has been directed to the backlight unit 12 of the display operating portion 10 configured to be lit with normal luminance immediately after startup, the present invention is not limited to this configuration and may change the color and the luminance of display data according to the content of the display data from immediately after startup. For example, the visibility of the display data of a menu screen displayed immediately after startup is not reduced even though the luminance of the backlight unit 12 is controlled to low luminance and the display data is displayed in monochrome. Therefore, from immediately after startup, the luminance of the backlight unit 12 may be controlled to low luminance and display data may be displayed in monochrome.

Furthermore, the configuration may be made such that a user can set whether the menu screen is displayed with low luminance and monochrome display data from immediately after startup as described above.

While the present embodiment has also described an example of the luminance of the backlight unit 12 set to 3 levels of luminance: normal luminance (high luminance), medium luminance, and low luminance, there is no limitation to this, and furthermore the luminance can be finely changed according to display data.

Moreover, in the above embodiments, an image forming apparatus provided with the display device of the present invention has been described as an example. However, the present invention is not limited to this configuration. The present invention can be applied to equipment provided with a display portion (a display device) such as a cellular phone and a personal computer.

The above described embodiments are to be considered in all respects as illustrative and not restrictive. The scope of the present invention is defined not by above described embodiments but by the claims. Further, the scope of the present invention is intended to include all modifications that come within the meaning and scope of the claims and any equivalents thereof.

What is claimed is:

1. A display device comprising:
a transmission type display panel that displays display data;
a backlight unit that emits light to a back side of the display panel;
a storage portion that stores a plurality of kinds of the display data to be displayed on the display panel and a plurality of kinds of luminance data to be set corresponding to each of the plurality of kinds of the display data; and
a control portion that performs display control for reading out from the storage portion the display data to be displayed on the display panel, the luminance data corresponding to the display data, displaying the read display data on the display panel, and controlling luminance of the backlight unit based on the read luminance data.

2. The display device according to claim 1, further comprising:
an operation portion that accepts an operation by a user; wherein the control portion performs the display control when the control portion shifts from a standby mode in which the luminance of the backlight unit is controlled to luminance lower than normal luminance of the backlight unit to a normal mode in which the operation portion accepts an operation and performs processing corresponding to the operation.

3. The display device according to claim 1, wherein the control portion gradually changes the luminance of the backlight unit every predetermined time based on the luminance data read out from the storage portion.

4. The display device according to claim 1, wherein the storage portion associates and stores monochrome display data in which the display data is displayed in monochrome on the display panel and low luminance data in which the luminance of the backlight unit is set to luminance lower than normal luminance of the backlight unit when the display data displayed on the display panel includes no figure.

5. The display device according to claim 2, wherein the storage portion associates and stores monochrome display data in which the display data is displayed in monochrome on the display panel and low luminance data in which the luminance of the backlight unit is set to luminance lower than the normal luminance of the backlight unit when the display data displayed on the display panel includes no figure.

6. The display device according to claim 3, wherein the storage portion associates and stores monochrome display data in which the display data is displayed in monochrome on the display panel and low luminance data in which the luminance of the backlight unit is set to luminance lower than normal luminance of the backlight unit when the display data displayed on the display panel includes no figure.

7. An image forming apparatus comprising:
a receiving portion that accepts a print job;
an image forming portion that prints on a recording medium print image data corresponding to the print job that is accepted by the receiving portion; and
the display device according to claim 1, wherein the display device displays display data on the display panel, the display data being related to the print job that is accepted by the receiving portion.

8. The image forming apparatus according to claim 7, wherein the control portion, when the receiving portion accepts a print job of a predetermined amount or more, reads out display data and luminance data from the storage portion and performs the display control, the display data being for confirming a progress state of the print job and the luminance data corresponding to the display data.
